(19) United States
(12) Patent Application Publication
(10) Pub. No.: US 2024/0284865 A1
(43) Pub. Date: Aug. 29, 2024

(54) Horse Transportation Trailer System

(71) Applicant: Brad Heath, Wilmington, NC (US)

(72) Inventor: Brad Heath, Wilmington, NC (US)

(21) Appl. No.: 18/588,357

(22) Filed: Feb. 27, 2024

Related U.S. Application Data
(60) Provisional application No. 63/487,115, filed on Feb. 27, 2023.

(51) Int. Cl. A01K 1/00; A01K 1/04; A01K 29/00; B33Y 80/00; B60J 1/14; B60P 1/43; B60P 3/04; B62D 29/04; B62D 63/08

(52) U.S. Cl. CPC A01K 1/0082; A01K 1/0035; A01K 1/0064; A01K 1/0094; A01K 1/04; A01K 29/005; B33Y 80/00; B60P 1/43; B60P 3/04; B62D 29/045; B62D 63/08; B60J 1/14

(57) ABSTRACT

An integrally formed horse transportation trailer including an internal airflow system designed to control airflow to individual horse stalls within the horse transportation trailer. The integrally formed horse transportation trailer includes an adjustable internal tie track, an external adjustable tie track, a fender skirt, a dress door, a moonroof, a climate control system, a bench set with an overhead clothes bar, a walkthrough door, an adjustable double-hinged divider, a side slide-in/slide out ramp, a rear slide-in/slide out ramp, and a removable rear loading compartment. The horse transportation trailer is further operable to haul in a forward and reverse facing direction.

### CROSS-REFERENCE TO RELATED APPLICATIONS

This application claims benefit to provisional application U.S. 63/487,115 filed on Feb. 27, 2023 and is incorporated in its entirety.

### FIELD OF INVENTION

The present subject matter is generally related to horse transportation trailers, more specifically to horse transportation trailers made of continuous construction with an internal airflow system.

### BACKGROUND OF THE INVENTION

Horse transportation trailers are attached to motor vehicles and used to transport across states and countries. Typical horse transportation trailers have problems including rusted frames, rotten floors, broken latches, poor electrical connections, weak structural integrity due to wall and roof structure, improperly designed tack areas, loose bolts that cause rattling noises, inadequate natural light, and restricted airflow.

Many horse transportation trailers use aluminum for the walls of a horse transportation trailer. Thin layers of aluminum are easily bent and dented, particularly when undergoing the force of a horse's kick. Even double-walled structures have difficulty withstanding the strength of a horse's kick. However, relying on stronger material can result in a wall being too strong and cause injury to a horse. Furthermore, thicker aluminum layers can become brittle and prone to cracking and breaking, particularly in welded areas. Therefore, there is a need for a horse transportation trailer wall structure that provides structural stability while avoiding injury to a horse.

Yet another problem with horse transportation trailers is the use of aluminum for the floor of the trailer. Aluminum flooring can transfer heat, noise, and vibration from the road to a horse, thereby causing fatigue and even injury to a horse. Therefore, there is a need for a horse transportation trailer that limits the vibration and noise experienced throughout the trailer.

Another problem with current horse transportation trailers includes inadequate natural lighting. An average 2-horse bumper pull trailer with conventional windows only has approximately 29 sq. ft. to allow natural light to come into the trailer. This is disadvantageous as horses do not like confined spaces but prefer ample natural lighting. Therefore, this is a need for a horse transportation trailer with adequate natural lighting.

An additional problem with current horse transportation trailers is the restricted airflow throughout the trailer. Generally, open windows are used to allow airflow through the horse transportation trailer. However, this negatively affects the aerodynamics of the trailer by increasing the air drag on the trailer. Further, the airflow provided by the window is not controllable, so horses may overheat as a result of poor airflow. Yet another problem with airflow in horse transportation trailers is that the design of the trailer can result in the horses positioned near the front of the trailer (e.g., closer to the tow vehicle) receiving less air than horses at the back. Therefore, in addition to the other problems with horse transportation trailers, there is a need for a horse transportation trailer with a controllable airflow system designed to control airflow to specific horses without increasing the air drag experienced by the horse transportation trailer.

Horse transportation trailers are manufactured in separate components and put together with welding and attachment components including bolts. Unfortunately, the quality of welding can affect the structural integrity of a horse transportation trailer. Further, the attachment components are prone to failure because of rust, vibration, and other external forces and conditions.

Yet another problem with horse transportation trailers is the negative environmental impact of manufacturing plants and the design limitations with manufacturing methods. Modern manufacturing plants have a large carbon footprint and provide limited design options for horse transportation trailers. Three-dimensional (3D) printing or additive manufacturing offers a small carbon footprint and relies on sustainable materials. However, current horse transportation trailers do not rely on 3D printed components because the 3D printed components are believed to be brittle and weak compared to conventional materials.

### SUMMARY OF THE INVENTION

The present invention is generally directed to a horse transportation trailer system including continuous construction and a controllable airflow system. The present horse transportation trailer system addresses the aforementioned problems with current horse transportation trailers while relying on unconventional features such as 3D printing.

In one embodiment, the present invention includes an integrally formed horse transportation trailer made via a 3D printing system.

In another embodiment, the present invention includes a 3D printed horse transportation trailer including an internal airflow system.

In yet another embodiment, the present invention includes an integrally formed horse transportation trailer including an internal airflow system for managing the temperature of each stall in the horse transportation trailer.

### BRIEF DESCRIPTION OF DRAWINGS

The embodiments illustrated, described, and discussed herein are illustrative of the present invention. As these embodiments of the present invention are described with reference to illustrations, various modifications, or adaptations of the methods and or specific structures described may become apparent to those skilled in the art. It will be appreciated that modifications and variations are covered by the above teachings and within the scope of the appended claims without departing from the spirit and intended scope thereof. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

FIG. 1 illustrates a schematic diagram of a horse transportation trailer according to one embodiment of the present invention.

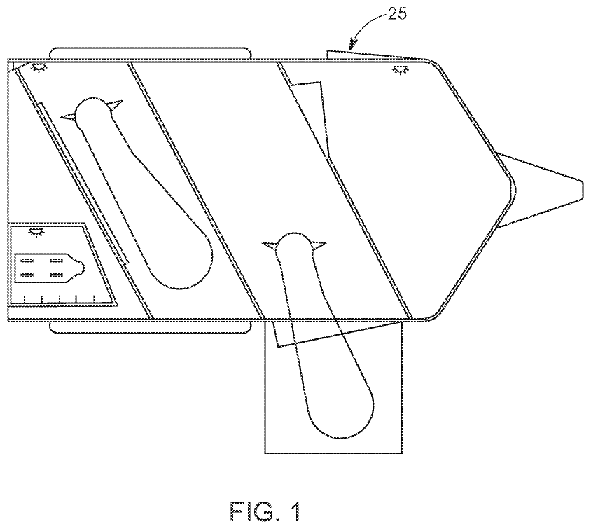

FIG. 2 illustrates a top perspective view of a horse transportation trailer according to one embodiment of the present invention.

FIG. 3 illustrates a side view of a horse transportation trailer according to one embodiment of the present invention.

FIG. 4 illustrates a side view of a horse transportation trailer according to one embodiment of the present invention.

FIG. 5 illustrates a side perspective view of a horse transportation trailer according to one embodiment of the present invention.

FIG. 6 illustrates a side perspective view of a horse transportation trailer according to one embodiment of the present invention.

FIG. 7 illustrates a front view of a horse transportation trailer according to one embodiment of the present invention.

FIG. 8 illustrates a rear view of a horse transportation trailer according to one embodiment of the present invention.

FIG. 9 illustrates a rear side perspective view of a horse transportation trailer according to one embodiment of the present invention.

FIG. 10 illustrates a side perspective view of a horse transportation trailer according to one embodiment of the present invention.

FIG. 11 illustrates a top perspective view of a horse transportation trailer according to one embodiment of the present invention.

FIG. 12 illustrates a top perspective view of a horse transportation trailer with open windows according to one embodiment of the present invention.

FIG. 13 illustrates a side perspective of a horse transportation trailer with an open side door according to one embodiment of the present invention.

FIG. 14 illustrates a rear side perspective view of a horse transportation trailer with an open side door and extended ramp according to one embodiment of the present invention.

FIG. 15 illustrates a side view of a horse transportation trailer with a side door and ramp in a closed position according to one embodiment of the present invention.

FIG. 16 illustrates a side perspective of a horse transportation trailer with an open side door according to one embodiment of the present invention.

FIG. 17 illustrates a rear side perspective view of a horse transportation trailer with an open rear door and extended tack compartment according to one embodiment of the present invention.

FIG. 18 illustrates a rear interior view of a horse transportation trailer according to one embodiment of the present invention.

FIG. 19 illustrates a rear view of a horse transportation trailer with an open rear door and extended tack compartment according to one embodiment of the present invention.

FIG. 20 illustrates a side perspective view of a horse transportation trailer including an open fender skirt according to one embodiment of the present invention.

FIG. 21 illustrates a side perspective view of a horse transportation trailer including an open side door, an open window, an open rear door, an extended tack compartment, and an extended rear ramp according to one embodiment of the present invention.

FIG. 22 illustrates a front side perspective view of a horse transportation trailer including an open side door, an open window, an open rear door, an extended tack compartment, and an extended side ramp according to one embodiment of the present invention.

FIG. 23 illustrates a side view of a horse transportation trailer including an open side door, an open rear door, and an open window according to one embodiment of the present invention.

FIG. 24 illustrates a rear perspective view of an interior of a horse transportation trailer without a rear door according to one embodiment of the present invention.

FIG. 25 illustrates a folded out fender skirt of a horse transportation trailer according to one embodiment of the present invention.

FIG. 26 illustrates an open window of a horse transportation trailer according to one embodiment of the present invention.

FIG. 27 illustrates a 3D printing system for a horse transportation trailer according to one embodiment of the present invention.

FIG. 28 illustrates a 3D printing system for a horse transportation trailer according to one embodiment of the present invention.

FIG. 29 illustrates a 3D printing system for a horse transportation trailer according to one embodiment of the present invention.

FIG. 30 illustrates a top view of a 3D printing system for a horse transportation trailer according to one embodiment of the present invention.

FIG. 31 illustrates a top view of a 3D printing system for a horse transportation trailer according to one embodiment of the present invention.

FIG. 32 illustrates a 3D printing system for a horse transportation trailer according to one embodiment of the present invention.

FIG. 33 illustrates a 3D printing system for a horse transportation trailer according to one embodiment of the present invention.

FIG. 34 illustrates an internal airflow system for a horse transportation trailer according to one embodiment of the present invention.

FIG. 35 illustrates a front perspective view of a horse transportation trailer including an external air inlet according to one embodiment of the present invention.

FIG. 36 illustrates a side perspective view of a horse transportation trailer including air outlets according to one embodiment of the present invention.

### DETAILED DESCRIPTION OF THE INVENTION

For the purpose of promoting an understanding of the present disclosure, reference will be made to preferred embodiments and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

Articles “a” and “an” are used herein to refer to one or to more than one (i.e., at least one) of the grammatical object of the article. By way of example, “a composite” means at least one composite and can include more than one composite.

Throughout the specification, the terms “about” and/or “approximately” may be used in conjunction with numerical values and/or ranges. The term “about” is understood to mean those values near to a recited value. For example, “about 40 [units]” may mean within +/−25% of 40 (e.g., from 30 to 50), within +/−20%, +/−15%, +/−10%, +/−9%, +/−8%, +/−7%, +/−6%, +/−5%, +/−4%, +/−3%, +/−2%, +/−1%, less than +/−1%, or any other value or range of values therein or there below. Furthermore, the phrases “less than about [a value]” or “greater than about [a value]” should be understood in view of the definition of the term “about” provided herein. The terms “about” and “approximately” may be used interchangeably.

As used herein, the verb “comprise” as is used in this description and in the claims and its conjugations are used in its non-limiting sense to mean that items following the word are included, but items not specifically mentioned are not excluded.

Throughout the specification the word “comprising,” or variations such as “comprises” or “comprising,” will be understood to imply the inclusion of a stated element, integer or step, or group of elements, integers, or steps, but not the exclusion of any other element, integer or step, or group of elements, integers, or steps. The present disclosure may suitably “comprise”, “consist of”, or “consist essentially of”, the steps, elements, and/or reagents described in the claims.

It is further noted that the claims may be drafted to exclude any optional element. As such, this statement is intended to serve as antecedent basis for use of such exclusive terminology as “solely”, “only”, and the like in connection with the recitation of claim elements, or the use of a “negative” limitation.

Unless defined otherwise, all technical and scientific terms used herein have the same meanings as commonly understood by one of ordinary skill in the art to which this disclosure belongs. Preferred methods, devices, and materials are described, although any methods and materials similar or equivalent to those described herein can be used in the practice or testing of the present disclosure. All references cited herein are incorporated by reference in their entirety.

In some embodiments, the present invention includes a horse transportation trailer that is integrally formed trailer. Current manufacturing methods of horse transportation trailers include combining separate components via various attachment mechanisms (e.g., bolts). This results in unevenly distributed loads throughout the entirety of the trailer. Furthermore, a majority of the load is carried by the chassis with minimal structural support from the roof. In comparison, the present invention is an integrally formed horse transportation trailer designed to distribute force loads to all areas of the trailer. In one embodiment, the horse transportation trailer is 3D printed and/or formed by other methods of additive manufacturing. In yet another embodiment, the integrally formed horse transportation trailer does not include any metals besides axles and a front coupler connected to a tow vehicle. For example, and not limitation, the horse transportation trailer includes a monocoque structure. The monocoque structure includes a chassis integral with the body of the horse transportation trailer.

In one embodiment, the present invention further includes a horse transportation trailer including a novel airflow system designed to deliver air to specific horse stalls via air units and vents positioned in the trailer wall. Advantageously, the airflow system enables the horse transportation trailer to travel with the windows closed while maintaining the internal airflow and temperature to maintain the comfort and health of the horse within the horse transportation trailer. One advantage of traveling with the windows closed is minimizing the noise within the trailer. Noise is one of many factors that can affect the comfort of a horse and can spook a horse, so limiting the noise within the trailer can improve the comfort and safety of a horse during transportation.

In some embodiments, the present invention includes a horse transportation trailer comprising a bat wing style window 5, an adjustable internal tie track 10, an external adjustable tie track 15, a fender skirt 20, a dress door 25, a moonroof 30, a climate control system 35, a bench seat 40 with an overhead clothes bar 45, a walkthrough door 50, an adjustable double-hinged divider 55, a side slide-in/slide out ramp 60, a rear slide-in/slide out ramp 65, and a removable rear tack compartment 70.

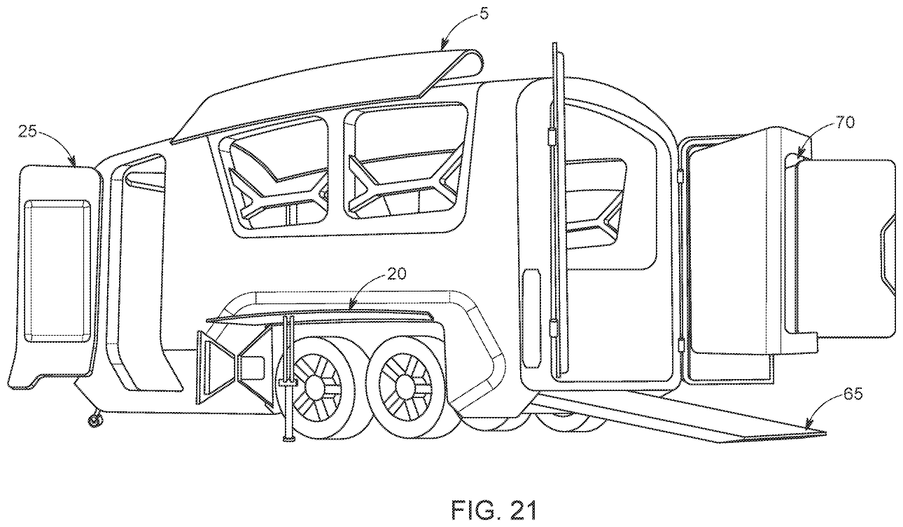

The bat wing style window includes a hinge positioned on the top of the roof and is noise canceling. Advantageously, the bat wing style window increases the amount of footage available for natural light because the hinge point allows for light to come in from all directions. For example, and not limitation, the horse transportation trailer includes approximately 69 sq. ft. of natural light due to the bat-wing style window. In some embodiments, the bat-wing style window is approximately 1 inch thick. In another example, the bat wing style window includes acrylonitrile butadiene styrene (ABS) and/or carbon fiber. FIGS. 21-23 are exemplary embodiments of a horse transportation trailer including at least one bat wing style window in an open position.

The external and internal adjustable tie tracks of the horse transportation trailer are operable to place horse ties in a plurality of positions to adapt to the size and shape of a horse within the trailer. The horse transportation trailer further includes a horse tie track designed to slidably adjust tie rings.

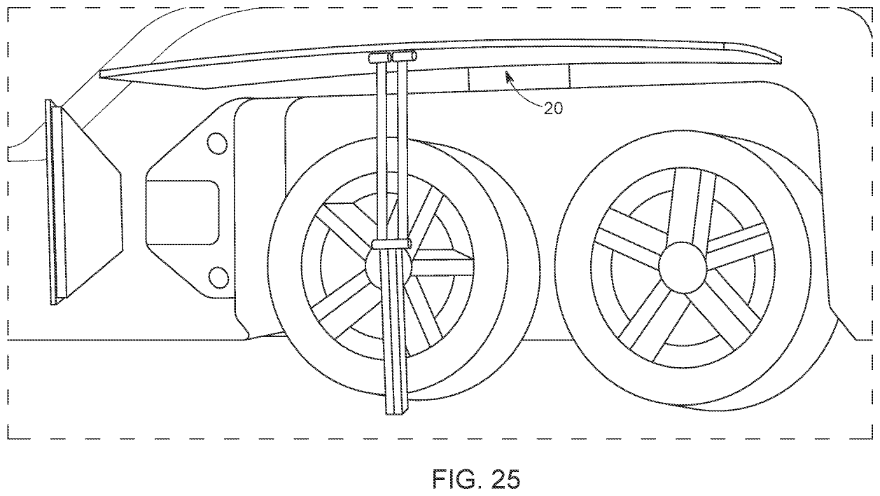

The fender skirt is designed to improve horse transportation trailers by covering the trailer during tire blowouts. The fender skirt further includes a wheel cover panel that is removable to provide access to a tire. The fender skirt is further designed to flip up with a fold-out leg to create a table as shown in FIG. 25. The fender skirt also improves the aerodynamics of the horse transportation trailer by forcing air to pass around the trailer instead of cutting underneath through the tire well. The slidable ramps of the horse transportation trailer include a hinge pivot and a low traction surface.

Yet another advantage of the present invention is the adjustable double-hinged divider. Generally, horse transportation trailers include internal dividers welded to a brace and attached to a vertical support structure. This limits the range and adjustability of the internal dividers. In comparison, the adjustable double-hinged divider of the present invention is operable to change the internal layout within the horse transportation trailer and to adapt to the size of a horse.

For example, and not limitation, the horse transportation trailer is operable to haul up to a 17.3 hand warmblood. In another embodiment, the horse trailer is designed to accommodate at least two warmblood horses that are up to 17.2 hands tall. The adjustable double-hinged dividers are designed to increase or decrease stall width based on a horse's size. In one embodiment, the double-hinged dividers are rotatably attached to a structure (e.g., vertical) positioned along or attached to the wall of the horse transportation trailers. Advantageously, the double-hinged dividers are designed to rotate towards and away from the middle of the trailer to create and restrict space as necessary.

The horse transportation trailer further includes tie rings. The tie rings include adjustable loops positioned along both the interior and exterior walls of the horse transportation trailer. For example, and not limitation, in one embodiment, the horse transportation trailer includes two ties for a horse and/or four horse ties per stall.

In yet another embodiment, the present invention includes a heat-resistant, leak-proof, fiber composite trailer roof material designed to keep a horse safe in the event that the horse is spooked and reared up. The horse transportation trailer further includes a protective trailer wall system comprising plastic and other polymer materials (e.g., rubber). Further, the horse transportation trailer includes a frame comprising a combination of zinc and chromate materials.

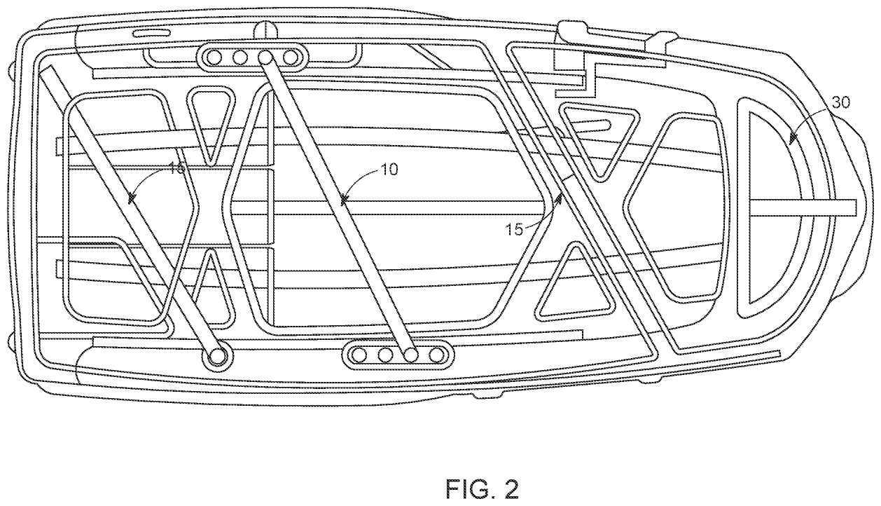

In yet another exemplary embodiment, the present invention includes a 3D printed horse transportation trailer. FIGS. 2-26 includes a 3D printed horse transportation trailer according to one embodiment of the present invention.

FIG. 2 illustrates a top perspective view of a horse transportation trailer according to one embodiment of the present invention.

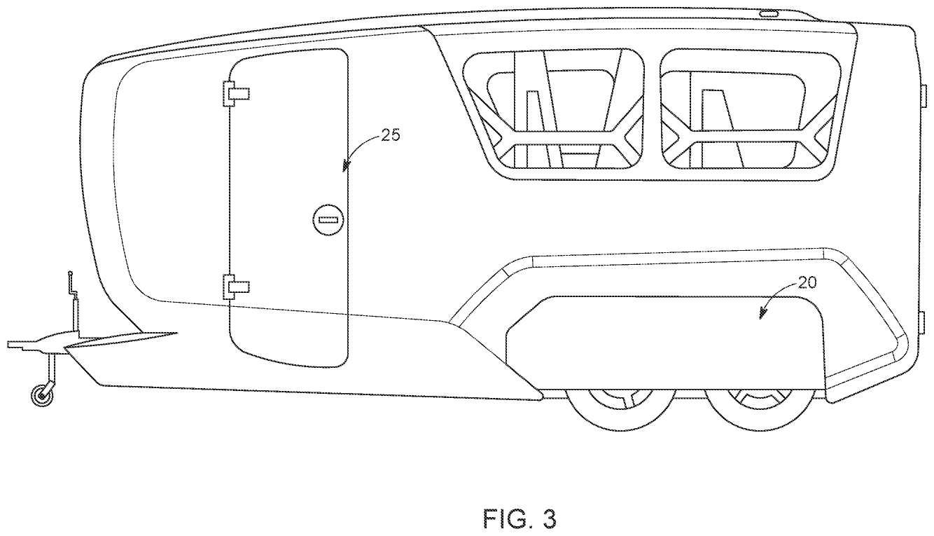

FIG. 3 illustrates a side view of a horse transportation trailer according to one embodiment of the present invention.

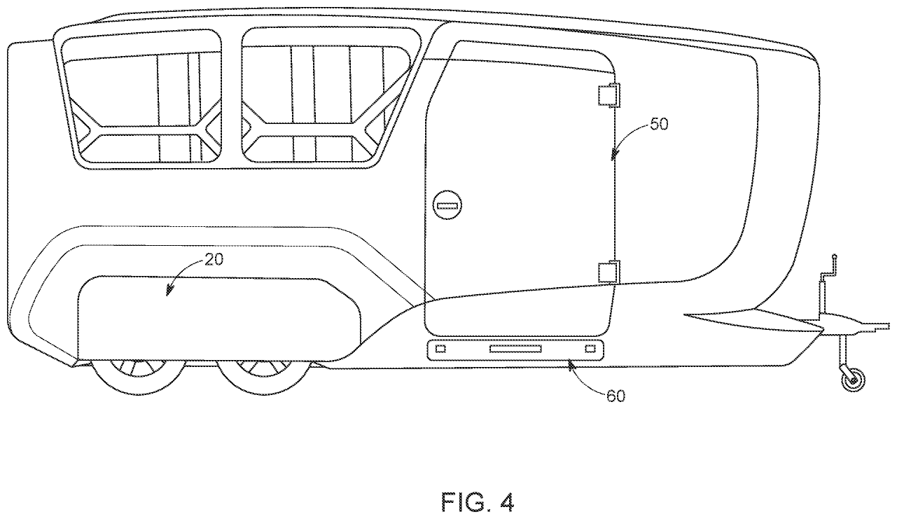

FIG. 4 illustrates a side view of a horse transportation trailer according to one embodiment of the present invention.

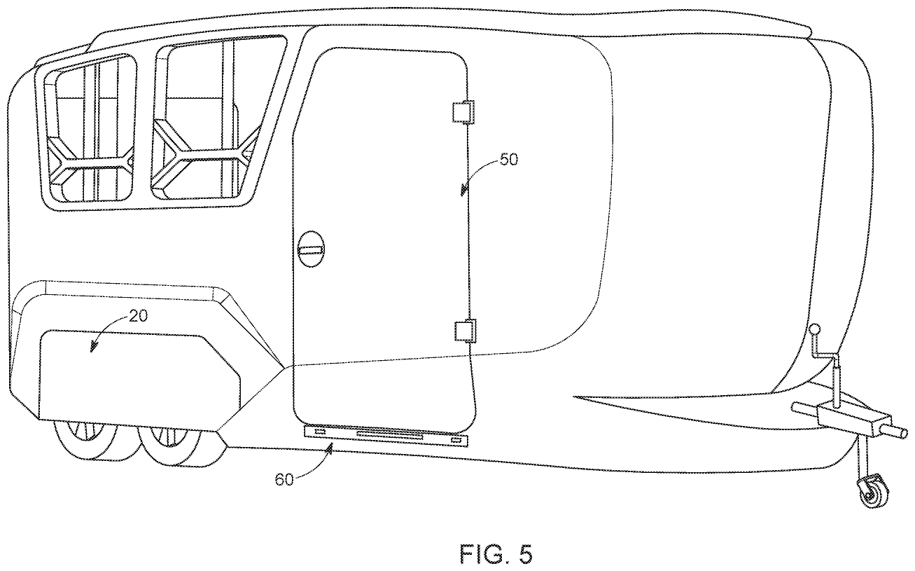

FIG. 5 illustrates a front side perspective view of a horse transportation trailer according to one embodiment of the present invention.

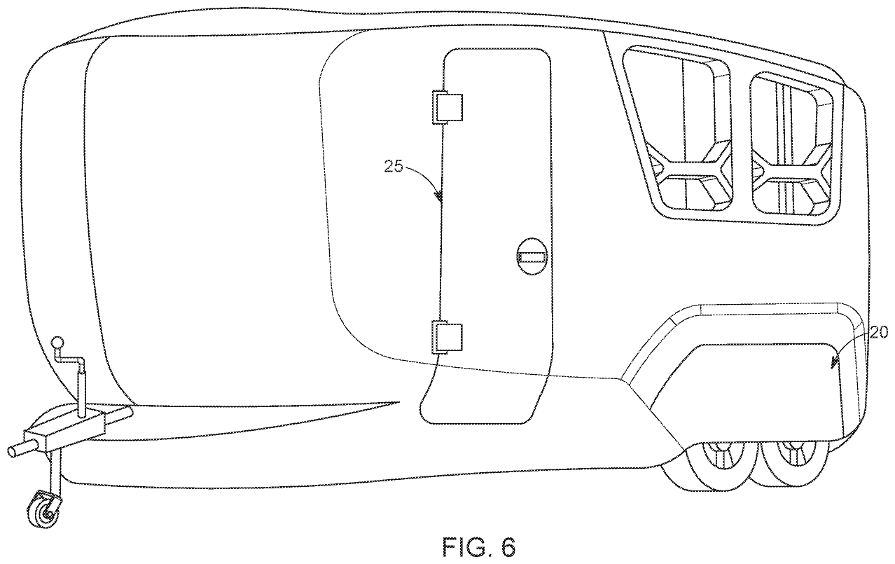

FIG. 6 illustrates a front side perspective view of a horse transportation trailer according to one embodiment of the present invention.

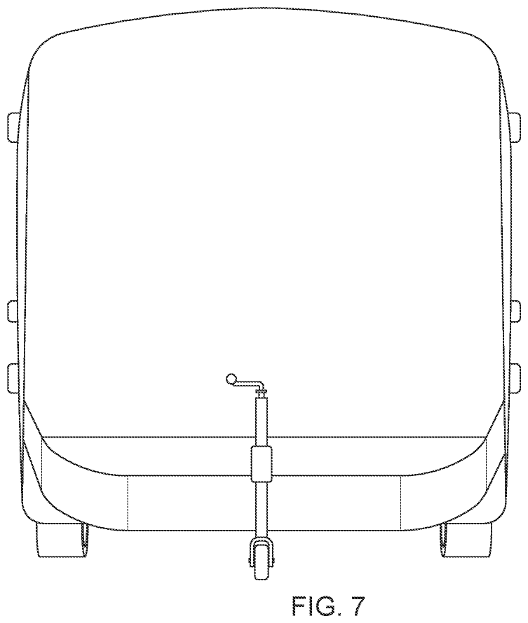

FIG. 7 illustrates a front view of a horse transportation trailer according to one embodiment of the present invention.

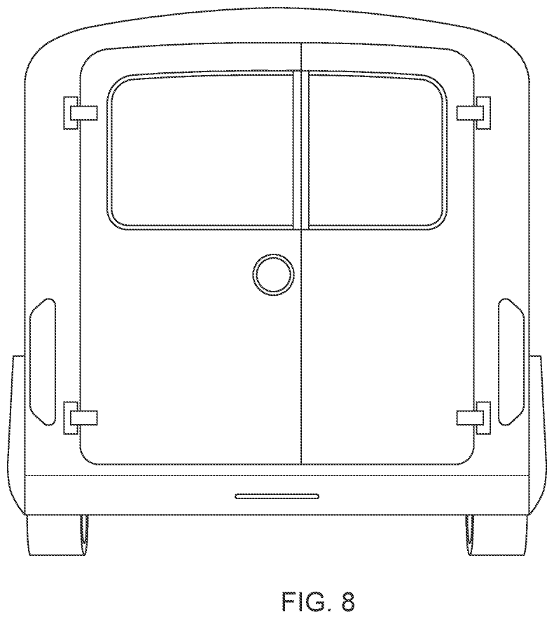

FIG. 8 illustrates a rear view of a horse transportation trailer according to one embodiment of the present invention.

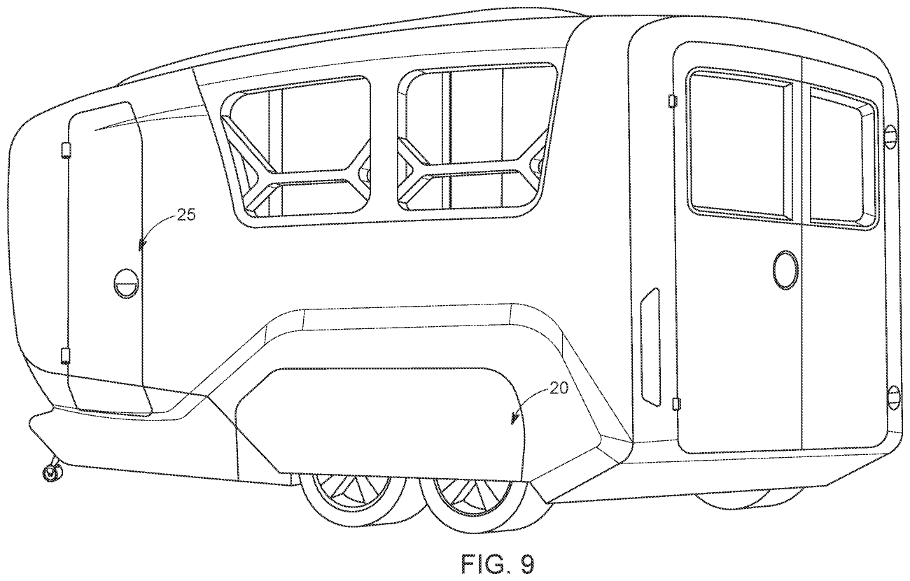

FIG. 9 illustrates a rear side perspective view of a horse transportation trailer according to one embodiment of the present invention.

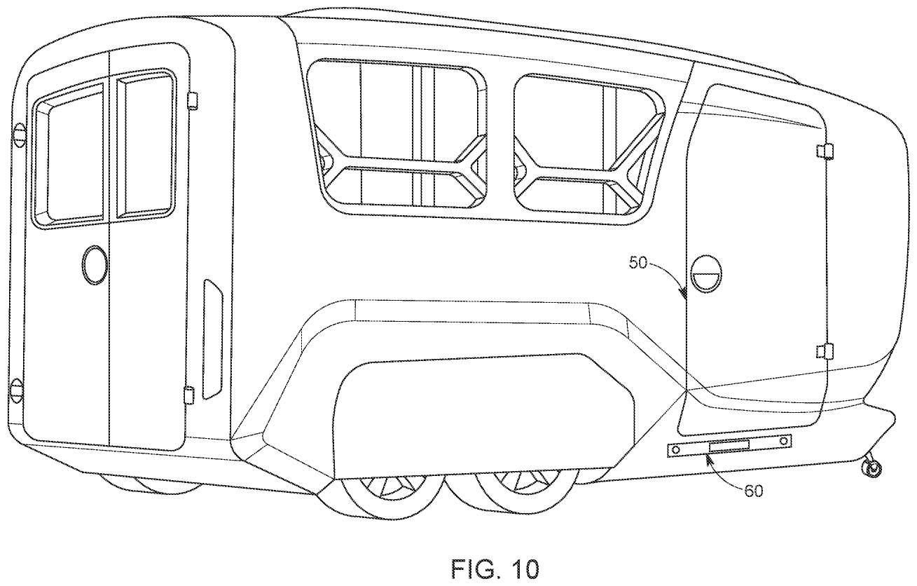

FIG. 10 illustrates a side rear perspective view of a horse transportation trailer according to one embodiment of the present invention.

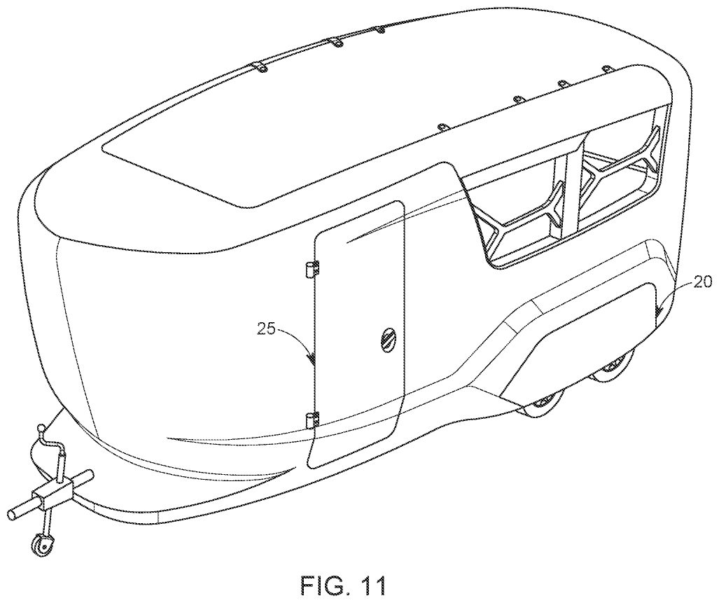

FIG. 11 illustrates a top perspective view of a horse transportation trailer according to one embodiment of the present invention.

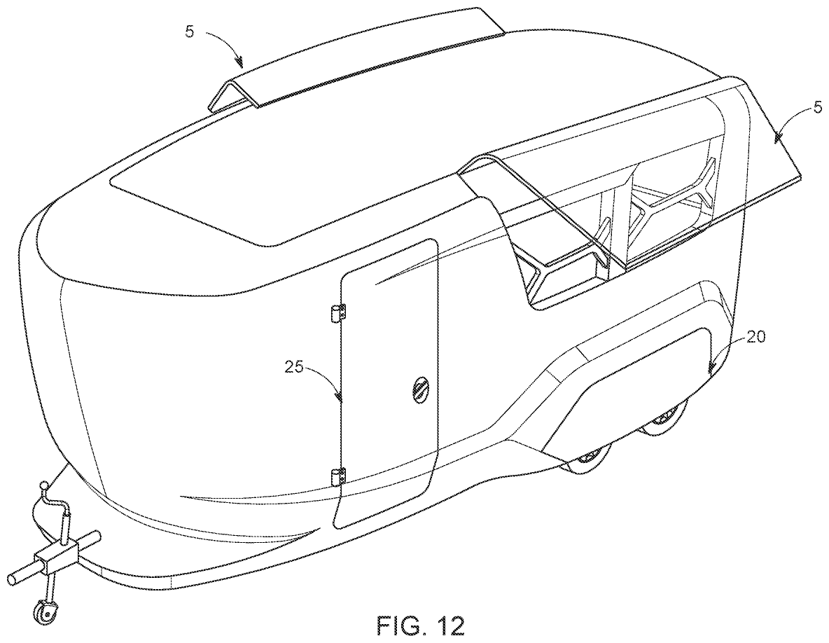

FIG. 12 illustrates a top perspective view of a horse transportation trailer with open windows according to one embodiment of the present invention.

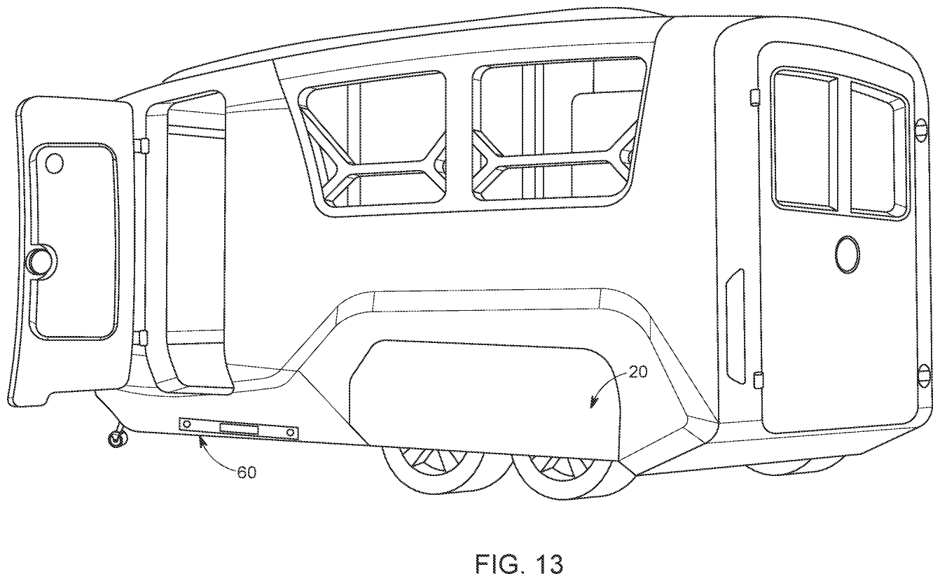

FIG. 13 illustrates a side perspective of a horse transportation trailer with an open side door according to one embodiment of the present invention.

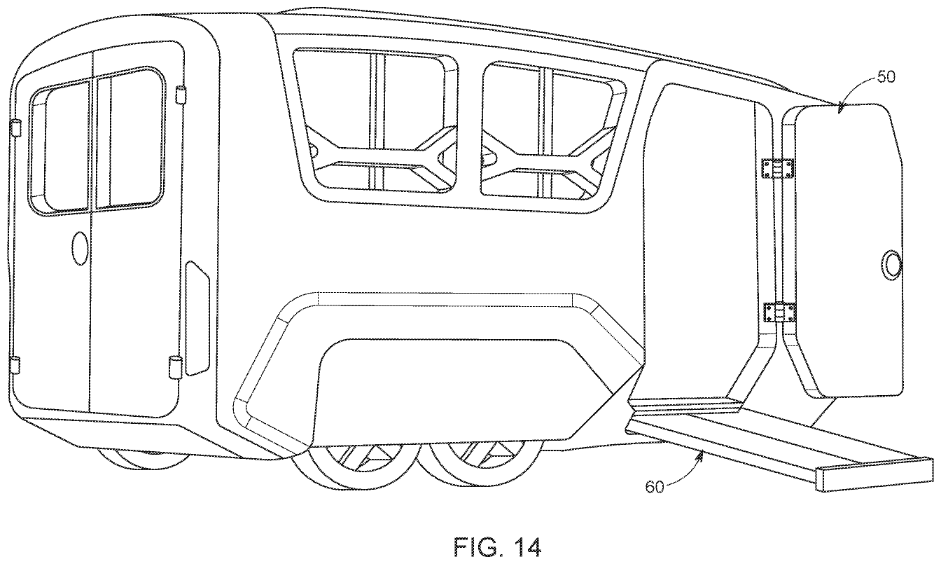

FIG. 14 illustrates a rear side perspective view of a horse transportation trailer with an open side door and extended ramp according to one embodiment of the present invention.

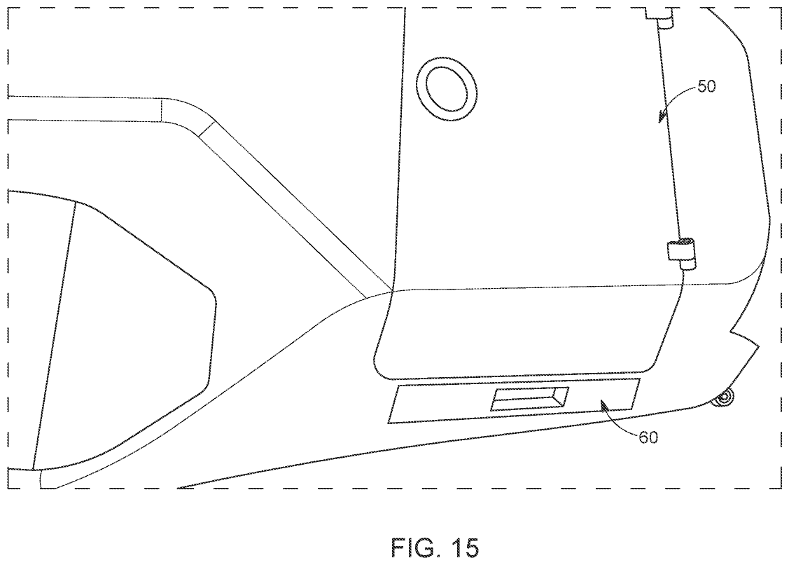

FIG. 15 illustrates a side view of a horse transportation trailer with a side door and ramp in a closed position according to one embodiment of the present invention.

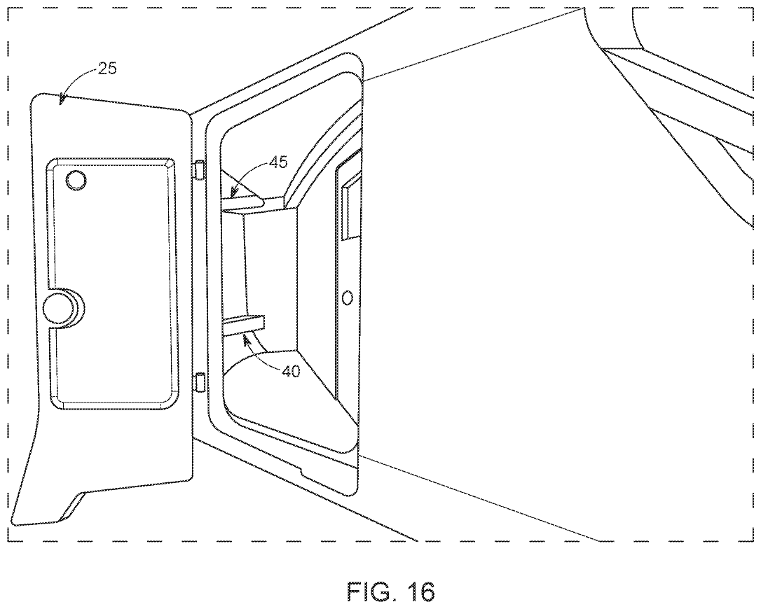

FIG. 16 illustrates a side perspective of a horse transportation trailer with an open side door according to one embodiment of the present invention.

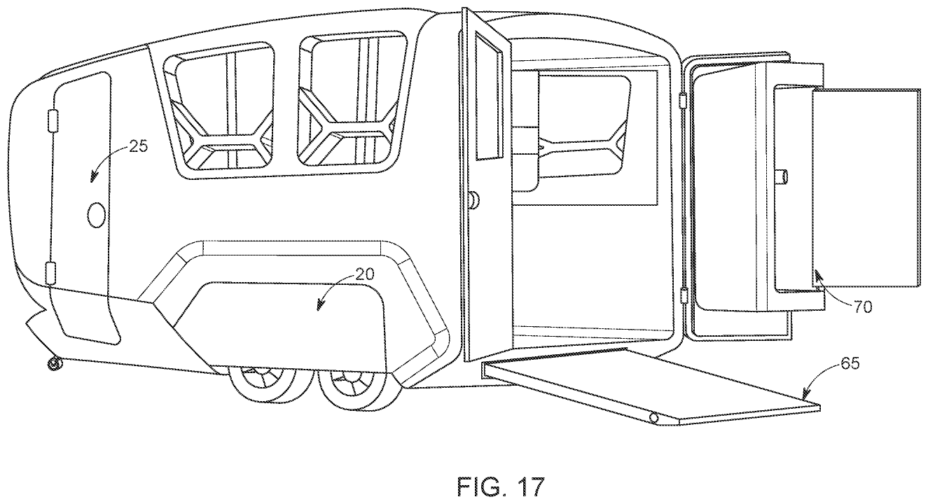

FIG. 17 illustrates a rear side perspective view of a horse transportation trailer with an open rear door and extended tack compartment according to one embodiment of the present invention.

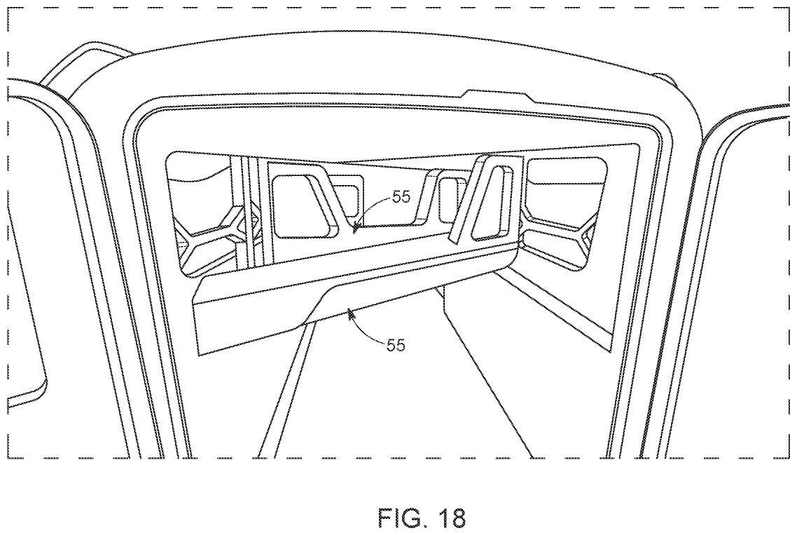

FIG. 18 illustrates a rear interior view of a horse transportation trailer according to one embodiment of the present invention.

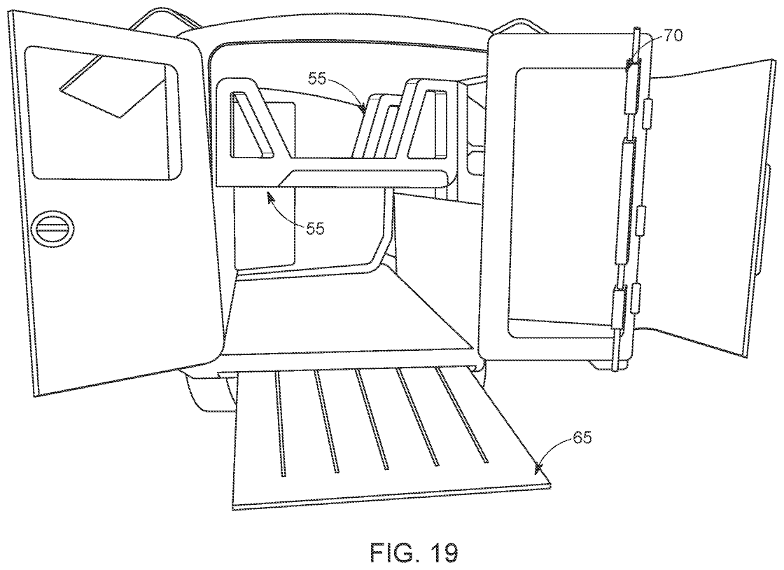

FIG. 19 illustrates a rear view of a horse transportation trailer with an open rear door and extended tack compartment according to one embodiment of the present invention.

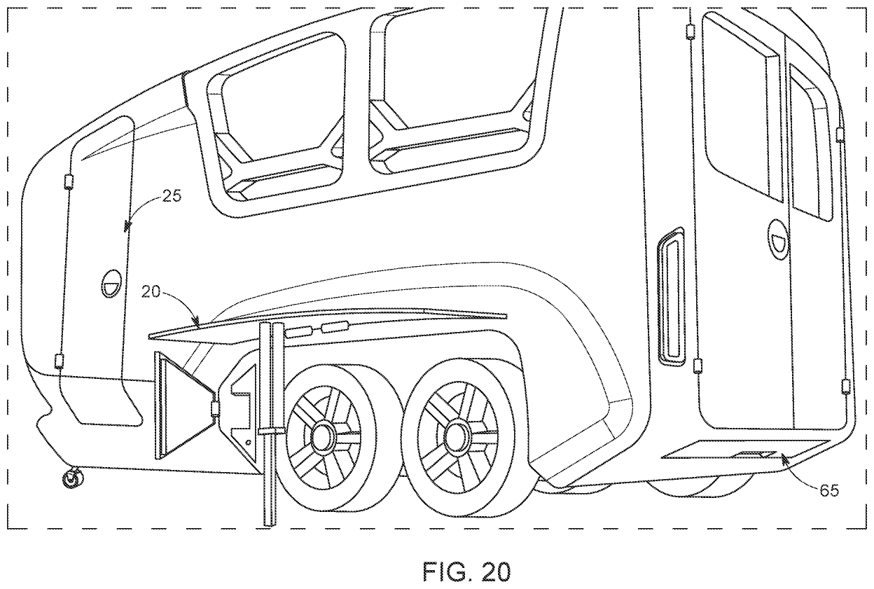

FIG. 20 illustrates a side perspective view of a horse transportation trailer including an open fender skirt according to one embodiment of the present invention.

FIG. 21 illustrates a side perspective view of a horse transportation trailer including an open side door, an open window, an open rear door, an extended tack compartment, and an extended rear ramp according to one embodiment of the present invention.

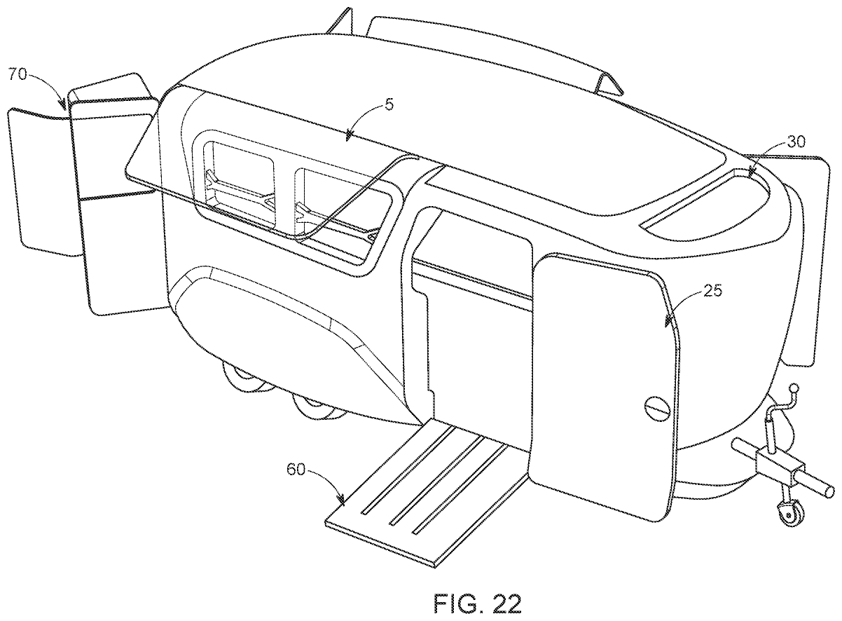

FIG. 22 illustrates a front side perspective view of a horse transportation trailer including an open side door, an open window, an open rear door, an extended tack compartment, and an extended side ramp according to one embodiment of the present invention.

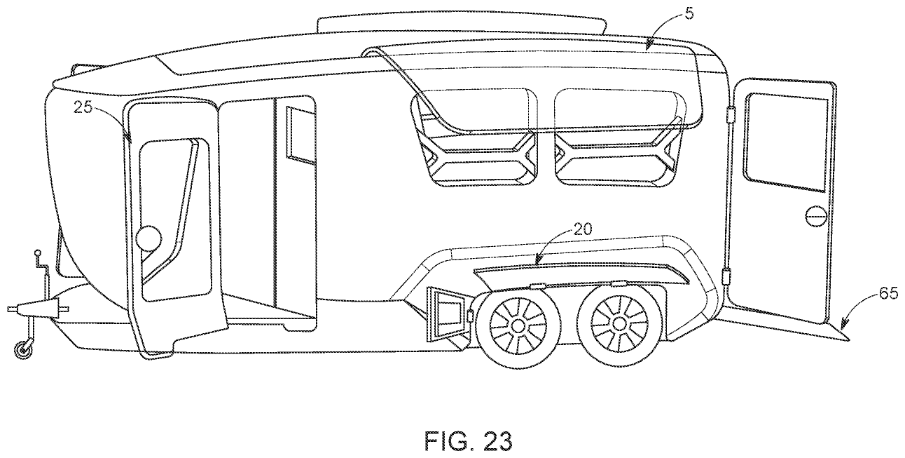

FIG. 23 illustrates a side view of a horse transportation trailer including an open side door, an open rear door, and an open window according to one embodiment of the present invention.

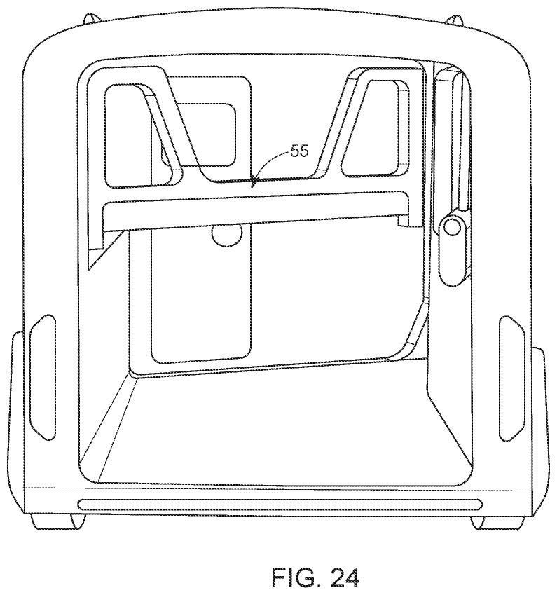

FIG. 24 illustrates a rear perspective view of an interior of a horse transportation trailer without a rear door according to one embodiment of the present invention.

FIG. 25 illustrates a folded out fender skirt of a horse transportation trailer according to one embodiment of the present invention.

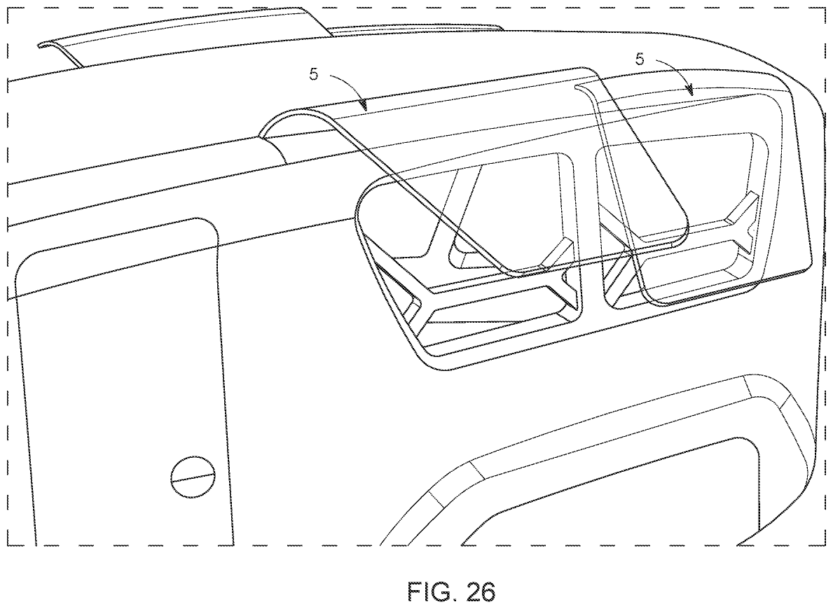

FIG. 26 illustrates an open window of a horse transportation trailer according to one embodiment of the present invention.

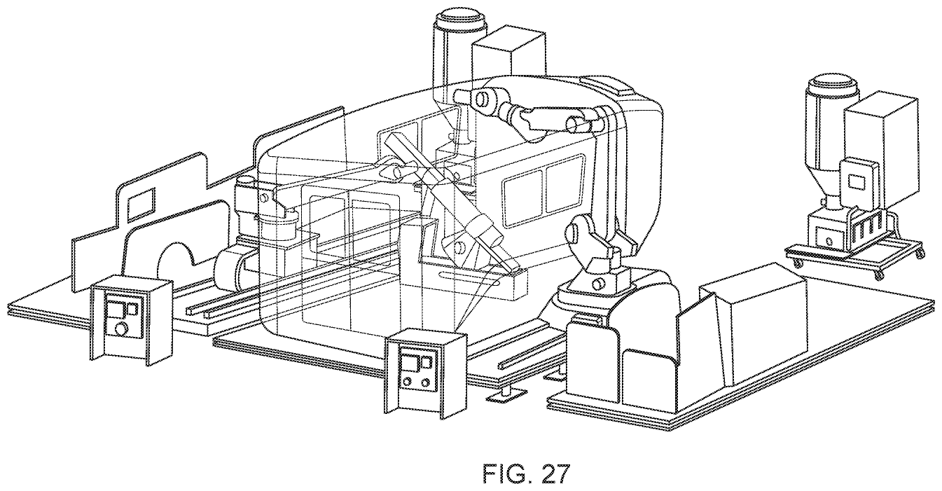

The 3D printed horse transportation trailer is manufactured using a robotic manufacturing system as shown in FIGS. 27-33. FIG. 27 illustrates a 3D printing system for a horse transportation trailer according to one embodiment of the present invention.

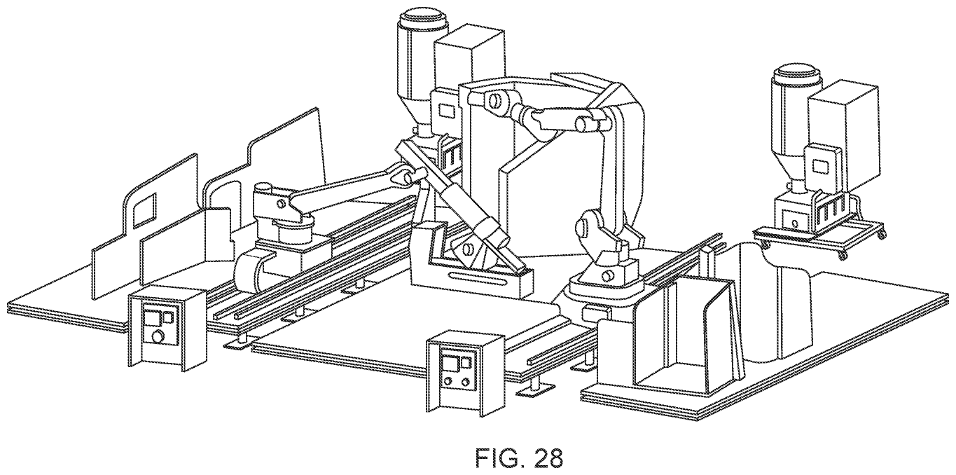

FIG. 28 illustrates a 3D printing system for a horse transportation trailer according to one embodiment of the present invention.

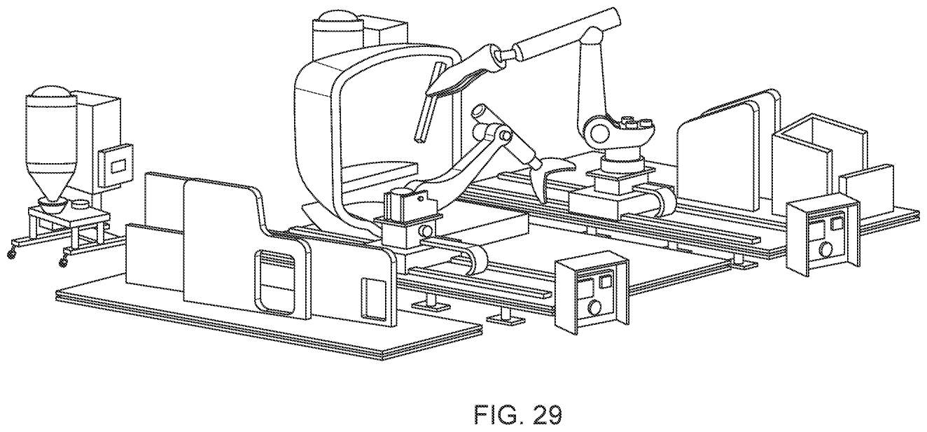

FIG. 29 illustrates a 3D printing system for a horse transportation trailer according to one embodiment of the present invention.

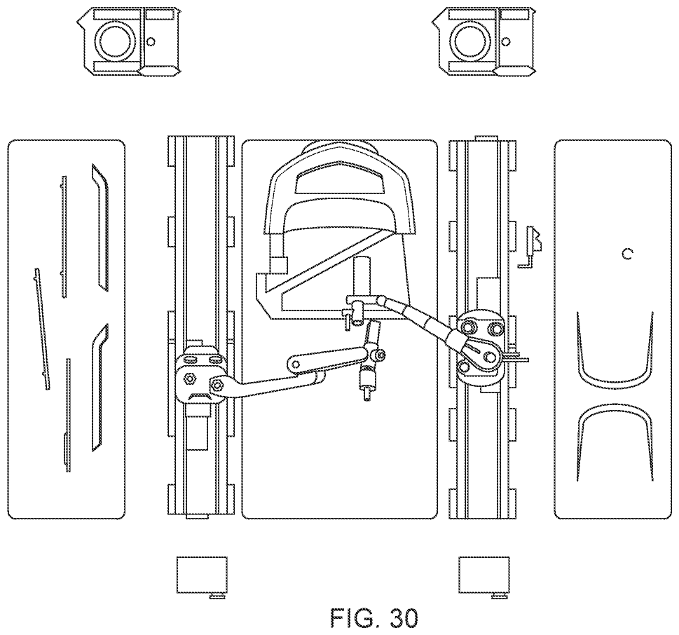

FIG. 30 illustrates a top view of a 3D printing system for a horse transportation trailer according to one embodiment of the present invention.

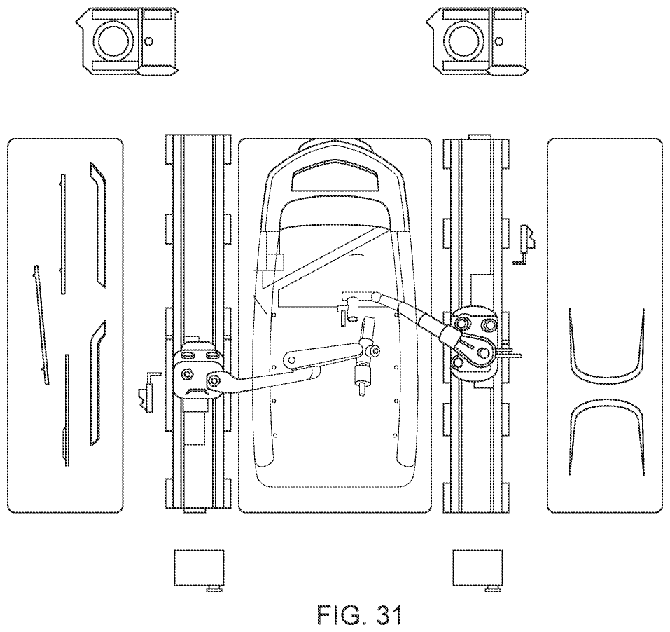

FIG. 31 illustrates a top view of a 3D printing system for a horse transportation trailer according to one embodiment of the present invention.

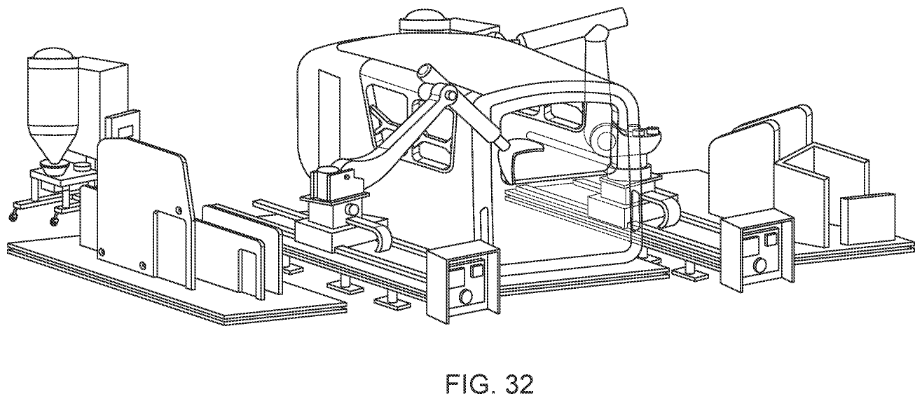

FIG. 32 illustrates a 3D printing system for a horse transportation trailer according to one embodiment of the present invention.

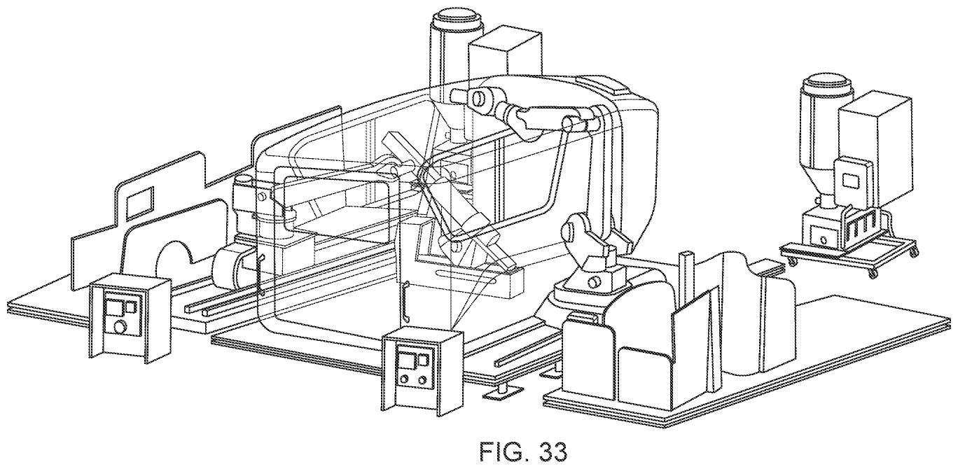

FIG. 33 illustrates a 3D printing system for a horse transportation trailer according to one embodiment of the present invention. For example, and not limitation, the robotic manufacturing system includes a 3D printer (e.g., robotic 3D polymer printer) and at least one robot positioned on a linear rail. The robotic 3D polymer printer includes a robotic arm and an extruder. The robotic arm is responsible for positioning the extruder and moving it through a computer driver path with an accuracy of 0.002 inches. The extruder further melts and deposits a polymer at a precise rate along a defined path to create a target wall thickness and layer height.

Advantageously, the 3D printing robotic is designed to create a standard forward-facing bumper pull trailer that weighs about 2,500 pounds and a reverse carbon trailer that is designed for at least one warmblood horse and reverse loading that weighs approximately 3,800 lbs. In comparison, current horse transportation trailers of similar shape and size would be about 5,100 lbs.

For example, and not limitation, in some embodiments, the 3D printed horse transportation trailer includes polycarbonate, carbon fiber, and fiber glass. Advantageously, the material is designed to be forgiving if a horse kicks the trailer such that the horse is not injured while maintaining the structural integrity so the horse doesn't kick through the trailer.

Advantageously, the horse transportation trailer is operable to withstand temperatures up to 270 degrees Fahrenheit and temperatures as low as negative 40 degrees Fahrenheit. In comparison, modern transportation trailers experience integrity and strength problems between 200 and 250 degrees Fahrenheit.

The tack compartment enables a reverse load trailer design. The horse transportation trailer is designed for a horse to walk on and walk off a trailer without having to turn around or back up. Additionally, the swing-out rear tack compartment functions as a second access door instead of being a stationary door, thereby providing additional access to the interior of the horse transportation trailer.

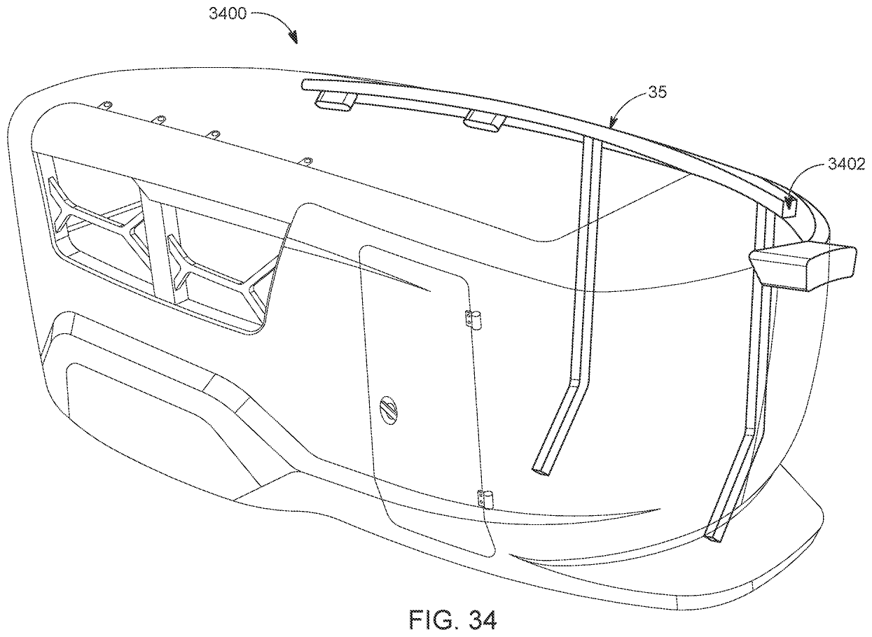

In another embodiment, as shown in FIG. 34, the horse transportation trailer 3400 includes an internal air duct system 3402 designed to control the airflow in and out of the horse transportation trailer. The internal air duct system includes a plurality of air ducts positioned within the walls of the horse transportation trailer that are designed for air transportation throughout the horse transportation trailer. The air duct system further includes a plurality of vertical tubes designed to function as water traps.

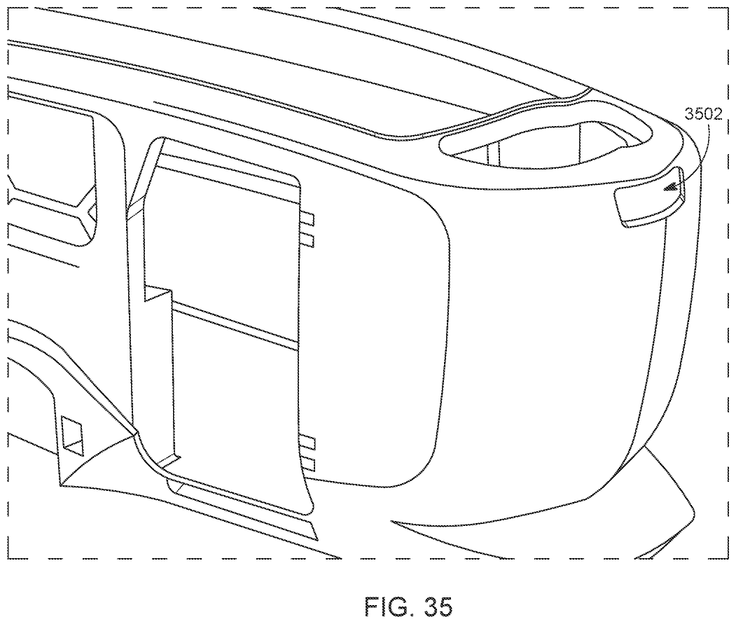

FIG. 35 illustrates a front perspective view of a horse transportation trailer including an external air inlet according to one embodiment of the present invention. For example, and not limitation, the air inlet 3502 includes a hinged cover designed to move between an open and a closed position to block and/or allow airflow to the horse transportation trailer. The air inlet is positioned near the top of the front side of the horse transportation trailer to pull air from the airstream created by a tow vehicle. Alternatively, or additionally, the horse transportation trailer includes an air inlet positioned on the side, rear, top, and/or bottom of the horse transportation trailer.

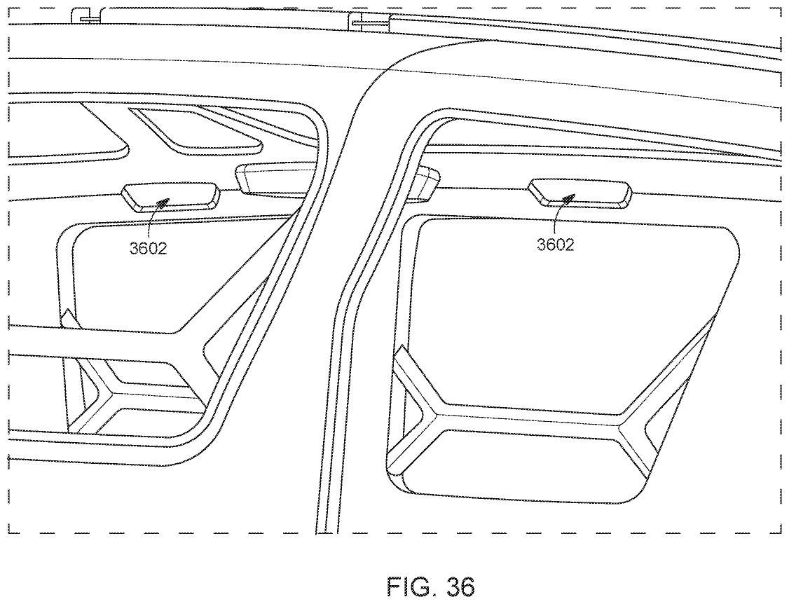

FIG. 36 illustrates a side perspective view of a horse transportation trailer including air outlets 3602 according to one embodiment of the present invention. Advantageously, in one embodiment, the horse transportation trailer includes at least one air outlet for each horse and/or horse stall.

In one embodiment, the horse transportation trailer includes at least one environmental sensor in network communication with a remote device. The environmental sensor includes, but is not limited to, a temperature sensor, an air quality sensor, a movement sensor, an image sensor, a tire pressure sensor, and/or a moisture sensor. The environmental sensor is designed to monitor the internal conditions and/or external conditions of the horse transportation trailer and generate an alert if the conditions exceed a threshold. For example, and not limitation, the environmental sensor is operable to determine whether the temperature inside the trailer is rapidly increasing and to transmit an alert to the internal airflow system to decrease the temperature.

Yet another example of the present invention includes a movement sensor operable to detect when a horse has increased movement. This is an indicator that the horse may be uncomfortable, and the movement sensor is operable to send an alert to the remote device. Another example of the present invention includes an image sensor (e.g., a camera) designed to capture images of the interior and/or exterior of the horse transportation trailer. The present invention is further operable to be in network communication with at least one body sensor (e.g., temperature, movement) attached to the horse and to provide real-time commands based on the condition of the horse.

Advantageously, the remote device is operable to send real-time or near real-time commands to the horse transportation trailer based on the sensor data. For example, and not limitation, the at least one remote device is operable to send a command to the airflow system to increase the amount of internal airflow based on the temperature inside the horse transportation trailer. Additionally, the present invention further includes a software platform designed to display real-time and historical trailer data, real-time and historical environmental sensor data, and real-time body and historical sensor data. Advantageously, the horse transportation trailer software platform is operable to display trends and changes in the trailer data, environmental sensor data, and the body sensor data.

In yet another embodiment, the horse transportation trailer is operable to generate a real-time or near real-time alert based on the real-time or near real-time horse physiological data, environment data, and/or airflow data. The at least one alert includes changes in environmental conditions (e.g., internal temperature), changes in horse physiological data (e.g., body temperature), changes in airflow activity (e.g., vent is blocked), and other similar alerts relating to the management of a horse transportation trailer. The at least one alert further includes a comparison of the real-time or near real-time horse physiological data, environment data, and/or airflow data to historical physiological data, environment data, and/or airflow data. Additionally, the present invention is configured to provide a recommendation based on the alert.

By way of example, and not limitation, if the horse transportation trailer determines that the internal temperature is increasing, then the present invention is operable to send a command to the climate control system to increase airflow to a horse to lower the temperature. The present invention is further operable to automatically contact a third-party based on the physiological data and the airflow data. For example, and not limitation, the present invention is operable to detect that the efficiency of the airflow system is declining and to request maintenance on the system.

In yet another embodiment, the horse transportation trailer includes a power component including a battery housing further including at least one battery. For example, and not limitation, the at least one battery includes a renewable battery. Alternatively, the at least one battery includes a non-renewable battery. In one embodiment, the at least one battery includes a lithium battery. In yet another embodiment, the battery housing includes a solar power storage component (e.g., solar battery).

In one embodiment, the power component includes control electronics. The control electronics include a voltage-sensing circuit, an analog-to-digital converter (ADC), a processor, the indicator, and optionally a driver. The voltage sensing circuit can be any standard voltage sensing circuit, such as those found in volt meters. An input voltage VIN is supplied via the power BUS. In one embodiment, the voltage sensing circuit includes standard amplification or de-amplification functions for generating an analog voltage that correlates to the amplitude of the input voltage VIN that is present. The ADC receives the analog voltage from the voltage sensing circuit and performs a standard analog-to-digital conversion.

The processor manages the overall operations of the horse transportation trailer. The processor is any controller, microcontroller, or microprocessor that is capable of processing program instructions. In one embodiment, the control electronics includes at least one antenna, which enables the horse transportation trailer to send information (e.g., internal temperature) to at least one remote device (e.g., smartphone, tablet, laptop computer) and/or receive information (e.g., airflow commands) from at least one remote device. The at least one antenna provides wireless communication, standards-based or non-standards-based, by way of example and not limitation, radiofrequency (RF), BLUETOOTH, ZIGBEE, NEAR FIELD COMMUNICATION (NFC), or other similar communication methods.

Any combination of one or more computer-readable medium(s) may be utilized. The computer-readable medium may be a computer readable signal medium or a computer-readable storage medium (including, but not limited to, non-transitory computer-readable storage media). A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including object oriented and/or procedural programming languages. Programming languages may include, but are not limited to: Ruby, JavaScript, Java, Python, Ruby, PHP, C, C++, C#, Objective-C, Go, Scala, Swift, Katlin, OCaml, SAS, Tensorflow, CUDA, or the like. The program code may execute entirely on the user's computer, partly on the user's computer, as a stand-alone software package, partly on the user's computer, and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

These computer program instructions may be provided to a processor of a general-purpose computer, special purpose computer, or other programmable data processing apparatus to produce a machine, such that the instructions, which execute via the processor of the computer or other programmable data processing apparatus, create an ability for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer-implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. least one specification heading is required.

1. A horse transportation trailer system, comprising a 3D-printed trailer of continuous construction, wherein the trailer is made of a preselected 3-D printable material.

2. The horse transportation trailer system of claim 1, wherein the printable material is selected from a 3-D printable polycarbonate material that, after being 3-D printed, has a predetermined rigidity value.

3. The horse transportation trailer system of claim 1, wherein the printable material is selected from a 3-D printable carbon fiber material that, after being 3-D printed, has a predetermined rigidity value.

4. The horse transportation trailer system of claim 1, wherein the printable material is selected from a 3-D printable fiberglass material that, after being 3-D printed, has a predetermined rigidity value.

5. The horse transportation trailer system of claim 1, wherein the trailer of continuous construction defines an internal airflow system comprising of a plurality of air ducts.

6. The horse transportation trailer system of claim 1, wherein the trailer includes a tack compartment.

7. The horse transportation trailer system of claim 1, wherein the trailer includes an internal tie track including a plurality of associated tie rings, wherein the tie rings are adjustable.

8. The horse transportation trailer system of claim 1, wherein the trailer includes an external tie track including a plurality of tie rings, wherein the tie rings are adjustable.

9. The horse transportation trailer system of claim 1, wherein the trailer includes a fender skirt.

10. The horse transportation trailer system of claim 1, wherein the trailer includes a dress door.

11. The horse transportation trailer system of claim 1, wherein the trailer includes a moonroof.

12. The transportation trailer system of claim 1, wherein the trailer includes a climate control system.

13. The horse transportation trailer system of claim 1, wherein the trailer includes a bench set including an associated overhead clothes bar.

14. The horse transportation trailer system of claim 1, wherein the trailer includes a walkthrough door.

15. The horse transportation trailer system of claim 1, wherein the trailer includes a double-hinged divider.

16. The horse transportation trailer system of claim 1, wherein the trailer includes a slide-in/slide-out ramp.

17. The horse transportation trailer system of claim 1, wherein the trailer includes a removable rear loading compartment.

18. The horse transportation trailer system of claim 1, wherein the trailer includes a composite trailer roof.

19. The horse transportation trailer system of claim 1, wherein the trailer includes an extended rear ramp.

20. The horse transportation trailer system of claim 1, wherein the trailer includes vertical tubes adapted and configured to function as water traps.

21. The horse transportation trailer system of claim 1, wherein the trailer includes an environmental sensor.

22. The horse transportation trailer system of claim 1, wherein the trailer includes air inlets.

23. The horse transportation trailer system of claim 1, wherein the trailer includes a plurality of bat wing style windows.

24. The horse transportation trailer system of claim 5, wherein the trailer defines a plurality of horse stalls, wherein the airflow system delivers air to predetermined ones of the plurality of horse stalls via an associated plurality of air inlet air units and associated vents positioned in the trailer along an associated plurality of predetermined locations.

25. The horse transportation trailer system of claim 23, wherein the bat wing style windows are each constructed of an acrylonitrile-butadiene-styrene material.

26. The horse transportation trailer system of claim 7, wherein the internal tie track is adapted and configured to engage and slidably adjust each tie ring of the plurality of tie rings.

27. The horse transportation trailer system of claim 15, wherein the trailer defines a stall and a middle, wherein the double-hinged divider is adjustable relative to the stall or the middle, wherein the adjustable double-hinged divider is adapted and configured to be able to increase or decrease stall width in relation to width of a horse in the stall, wherein the double-hinged dividers are adapted and configured to be rotatable about an axis toward and/or away from the trailer middle to increase or reduce space as needed.

28. The horse transportation trailer system of claim 7, wherein the tie rings include adjustable loops positioned along interior and/or exterior walls of the horse transportation trailer.

29. The horse transportation trailer system of claim 18, wherein the composite trailer roof includes an effective amount of a material to keep a horse safe in the event the horse rears up.

30. The horse transportation trailer system of claim 6, wherein the tack compartment is adapted and configured, for enabling a horse to enter and/or exit the trailer without needing to turn around or back up.

31. The horse transportation trailer system of claim 6, wherein the tack compartment functions as a second access door instead of as a stationary door, thereby providing additional access to the tack compartment interior of the transportation trailer.

32. The horse transportation trailer system of claim 21, wherein the environmental sensor measures temperature.

33. The horse transportation trailer system of claim 21, wherein the environmental sensor measures air quality.

34. The horse transportation trailer system of claim 21, wherein the environmental sensor is a movement sensor.

35. The horse transportation trailer system of claim 21, wherein the environmental sensor is an image sensor.

36. The horse transportation trailer system of claim 21, wherein the environmental sensor is a moisture sensor.

37. The horse transportation trailer system of claim 21, wherein the environmental sensor is a tire pressure sensor.

38. The horse transportation trailer system of claim 21, wherein the trailer includes an internal airflow system, and wherein the environmental sensor activates the internal airflow system to decrease the temperature.
